(19) United States
(12) Patent Application Publication
(10) Pub. No.: US 2025/0113265 A1
(43) Pub. Date: Apr. 3, 2025

(54) USER EQUIPMENT BASED TIMING ADVANCE MEASUREMENTS

(71) Applicant: Nokia Technologies Oy, Espoo (FI)

(72) Inventors: Sanjay GOYAL, Murray Hill, NJ (US); Timo KOSKELA, Oulu (FI); Riikka Karoliina DIMNIK, Espoo (FI); Jani-Pekka KAINULAINEN, Cambridge (GB); Lars DALSGAARD, Oulu (FI)

(21) Appl. No.: 18/887,710

(22) Filed: Sep. 17, 2024

Related U.S. Application Data
(60) Provisional application No. 63/586,912, filed on Sep. 29, 2023.

(51) Int. Cl. H04W 36/00; H04W 36/08

(52) U.S. Cl. CPC H04W 36/0072; H04W 36/0085; H04W 36/08

(57) ABSTRACT

Systems, methods, apparatuses, and computer program products for user equipment based timing advance measurements. The method may include receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. User equipment-based timing advance measurements for the plurality of cells according to the second user equipment-based timing advance measurements behavior based on the indication may be performed.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for user equipment based timing advance measurements.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

An embodiment may be directed to an apparatus. The apparatus may include at least one processor and at least one memory storing instructions. The instructions stored in the at least one memory, when executed by the at least one processor may cause the apparatus at least to perform receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. The second user equipment-based timing advance measurements behavior may include decreased timing advance measurement frequency for a first cell among the plurality of cells compared to a timing advance measurement frequency of the first cell in the first user equipment-based timing advance measurements behavior. User equipment-based timing advance measurements for the plurality of cells according to the second user equipment-based timing advance measurements behavior based on the indication may be performed.

Another embodiment may be directed to an apparatus. The apparatus may include at least one processor and at least one memory storing instructions. The instructions stored in the at least one memory, when executed by the at least one processor may cause the apparatus at least to perform sending, to a user equipment configured to perform user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. A layer one measurement report may be received from the user equipment. An early transmission configuration indication state activation medium access control element for a second cell among the plurality of cells based on the layer one measurement report may be sent.

An embodiment may be directed to a method. The method may include receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. The second user equipment-based timing advance measurements behavior may include decreased timing advance measurement frequency for a first cell among the plurality of cells compared to a timing advance measurement frequency of the first cell in the first user equipment-based timing advance measurements behavior. User equipment-based timing advance measurements for the plurality of cells according to the second user equipment-based timing advance measurements behavior based on the indication may be performed.

Another embodiment may be directed to a method. The method may include sending, to a user equipment configured to perform user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. A layer one measurement report may be received from the user equipment. An early transmission configuration indication state activation medium access control element for a second cell among the plurality of cells based on the layer one measurement report may be sent.

Another embodiment may be directed to an apparatus. The apparatus may include means for receiving a layer 1/layer 2 triggered mobility configuration for one or more candidate target cells, wherein UE-based TA measurement is enabled for a plurality of cells comprising the one or more candidate target cells, means for performing user equipment-based timing advance measurements for the plurality of cells according to a first user equipment-based timing advance measurements behavior during a layer 1/layer 2 triggered mobility procedure, and means for receiving an indication to enable a second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. The apparatus may further include means for performing user equipment-based timing advance measurements for the plurality of cells according to the second user equipment-based timing advance measurements behavior based on the indication.

Another embodiment may be directed to an apparatus. The apparatus may include means for sending, to a user equipment configured to user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. The apparatus may further include means for receiving a layer one measurement report from the user equipment and means for sending an early transmission configuration indication state activation medium access control element for a second cell among the plurality of cells based on the layer one measurement report.

Another embodiment may be directed to an apparatus comprising circuitry configured to perform a method. The method may include receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. The second user equipment-based timing advance measurements behavior may include decreased timing advance measurement frequency for a first cell among the plurality of cells compared to a timing advance measurement frequency of the first cell in the first user equipment-based timing advance measurements behavior. User equipment-based timing advance measurements for the plurality of cells according to the second user equipment-based timing advance measurements behavior based on the indication may be performed.

Another embodiment may be directed to an apparatus comprising circuitry configured to perform a method. The method may include sending, to a user equipment configured to user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. A layer one measurement report may be received from the user equipment. An early transmission configuration indication state activation medium access control element for a second cell among the plurality of cells based on the layer one measurement report may be sent.

Another embodiment may be directed to a non-transitory computer readable medium comprising program instructions stored thereon that, when executed by an apparatus, cause the apparatus to perform at least a method. The method may include receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. The second user equipment-based timing advance measurements behavior may include decreased timing advance measurement frequency for a first cell among the plurality of cells compared to a timing advance measurement frequency of the first cell in the first user equipment-based timing advance measurements behavior. User equipment-based timing advance measurements for the plurality of cells according to the second user equipment-based timing advance measurements behavior based on the indication may be performed.

Another embodiment may be directed to a non-transitory computer readable medium comprising program instructions stored thereon that, when executed by an apparatus, cause the apparatus to perform at least a method. The method may include sending, to a user equipment configured to user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. A layer one measurement report may be received from the user equipment. An early transmission configuration indication state activation medium access control element for a second cell among the plurality of cells based on the layer one measurement report may be sent.

Another embodiment may be directed to a computer program comprising instructions, which, when executed by an apparatus, cause the apparatus to perform a method. The method may include receiving a layer 1/layer 2 triggered mobility configuration for one or more candidate target cells, wherein UE-based TA measurement is enabled for a plurality of cells comprising the one or more candidate target cells and performing user equipment-based timing advance measurements for the plurality of cells according to a first user equipment-based timing advance measurements behavior during a layer 1/layer 2 triggered mobility procedure. An indication to enable a second user equipment-based timing advance measurements behavior may be received. The second user equipment-based timing advance measurements behavior may include decreased timing advance measurement frequency for a first cell among the plurality of cells compared to a timing advance measurement frequency of the first cell in the first user equipment-based timing advance measurements behavior. User equipment-based timing advance measurements for the plurality of cells according to the second user equipment-based timing advance measurements behavior based on the indication may be performed.

Another embodiment may be directed to a computer program comprising instructions, which, when executed by an apparatus, cause the apparatus to perform a method. The method may include sending, to a user equipment configured to user equipment-based timing advance measurements for a plurality of cells according to a first user equipment-based timing advance measurements behavior during a layer 1/layer 2 trigger mobility procedure, an indication to enable second user equipment-based timing advance measurements behavior. The second user equipment-based timing advance measurements behavior may include decreased timing advance measurement frequency for a first cell among the plurality of cells compared to a timing advance measurement frequency of the first cell in the first user equipment-based timing advance measurements behavior. A layer one measurement report may be received from the user equipment. An early transmission configuration indication state activation medium access control element for a second cell among the plurality of cells based on the layer one measurement report may be sent.

### BRIEF DESCRIPTION OF THE DRAWINGS

For proper understanding of example embodiments, reference should be made to the accompanying drawings, wherein:

FIG. 1 illustrates an example signal diagram of communications between a user equipment (UE), and a network base station (gNB), according to certain example embodiments;

FIG. 2 illustrates an example signal diagram of communications between a UE, gNB cell A, and a gNB cell B, according to certain example embodiments;

FIG. 3 illustrates an example timing diagram, according to certain example embodiments;

FIG. 4 illustrates an example signal diagram of communications between a UE, a gNB source, and a gNB target, according to certain example embodiments;

FIG. 5 illustrates an example flow diagram of a method, according to certain example embodiments;

FIG. 6 illustrates an example flow diagram of another method, according to certain example embodiments; and

FIG. 7 illustrates a set of apparatuses, according to some example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for user equipment based timing advance measurements.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

In the following discussion, the terms candidate cell and candidate target cell are used interchangeably. A target cell may refer to a candidate cell which is selected for the UE to handover to based on layer 1/layer 2 triggered mobility (LTM) decision and which becomes the UE's serving cell after the cell switch. Additionally, handover, layer 1/layer 2 (L1/2) triggered mobility, L1/2 inter-cell mobility, L1/2 handover, and lower layer (L1/2) mobility may be used interchangeably. Further, the terms “cell”, “node”, “gNB”, “network”, or other similar language throughout this specification may be used interchangeably. Further, the term measurement frequency is used to represent the number of measurements where higher measurement frequency means higher number of measurements, each measurement is performed at a different time, and lower measurement frequency means lower number of measurements. In one example, higher measurement frequency may mean performing measurement with a lower or smaller periodicity value (if a periodicity value is configured) and lower measurement frequency may mean performing measurement with a higher or longer periodicity value (if a periodicity value is configured).

User equipment (UE)-based timing advance (TA) measurements may be configured for one or more candidate cells, e.g., in the handover preparation phase (in the radio resource control (RRC) configuration). With UE-based TA measurement for a candidate cell, UE derives TA for the candidate cell based on receive (Rx) timing difference measurement between current serving cell and the candidate cell as well as TA value for the current serving cell. The Rx timing difference measurement between current serving cell and the candidate cell may be performed by estimating timing difference between time of arrival of a downlink reference signal (RS) from the current serving cell and time of arrival of a downlink reference signal (RS) from the candidate cell. UE based TA estimation enables the UE to estimate the TA of a candidate cell without requiring any random-access channel (RACH) procedure. This prevents the UE from experiencing interruption or delay due to RACH procedure (each physical random access channel (PRACH) preamble transmission towards the target cell is subject to interruption between the UE and the serving cell). The TA may be subject to validity for every ms during UE mobility, and the UE may be expected to continue estimating or updating the TA measurement along with its mobility.

UE based TA measurement is also time and energy consuming, and therefore it may be advantageous from the UE point of view that the UE would not need to perform TA measurements when they are not needed.

In layer 1/layer 2 trigger mobility (LTM), early candidate cell transmission configuration indication (TCI) state activation (e.g., candidate TCI activation medium access control element (MAC-CE) before the cell switch may be sent to the UE) is supported to prepare the UE for LTM cell switching and enable a shorter interruption at cell switch. The cell switch will happen within a short time frame after the early candidate cell TCI state activation. In some cases, the network may only do the early activation for the candidate cell that the network considers the likely target cell. Therefore, the time period between the early TCI state activation and LTM cell switch command may not be a period when measuring and reporting all candidate cells gives many benefits to the network LTM cell switch decision. Early TCI activation may be done for one or more TCI states associated with one or more candidate cells. One or more MAC-CE commands may be used for early TCI activation for one or more TCI states associated with one or more candidate cells.

New TA measurements may be configured and possibly activated by the network after early candidate cell TCI state activation. These TA measurements are different from the existing network requested UE assisted early TA acquisition procedure (e.g., involves RACH-based procedure).

When the UE receives, from the network, the Candidate Cell TCI Activation/Deactivation MAC-CE (or multiple MAC-CEs) activating one or more TCI states for one or more LTM candidate cells, the UE may continue or initiate UE-based TA measurements on the LTM candidate cells/RS for which TCI state(s) are activated and relax or stop the UE-based TA measurements on other configured LTM candidate cells/RS. The time duration during which the special UE-based TA measurement behavior occurs may be controlled with a timer. Alternatively, the special UE-based TA measurement behavior may continue until an explicit or implicit indication is received by the UE. For example, the special UE-based TA measurement behavior may continue until the UE receives the LTM cell switch command, a new candidate cell LTM TCI state activation command, a candidate cell LTM TCI state deactivation command, or a new LTM candidate cell configuration.

The behavior for UE-based TA measurement may also be enabled based on the early beam indication or RACH-based early TA acquisition status.

This special UE-based TA measurement behavior may be defined in a standard or it may be network configured. For the latter case, related network signaling to enable, disable or define the UE measurement behavior may be included in a LTM measurement configuration and/or early TCI state activation MAC-CE. The UE may signal its capability in terms of maximum number of candidate cells for which the UE may perform UE-based TA measurements, and the number of candidate cells for TA measurements may be equal to or less than the maximum number of candidate cells.

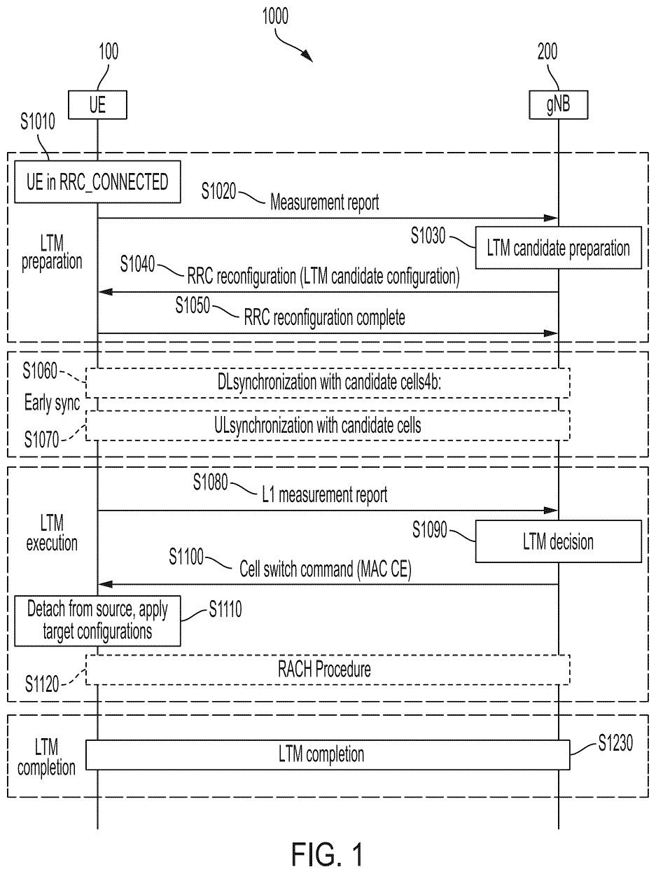

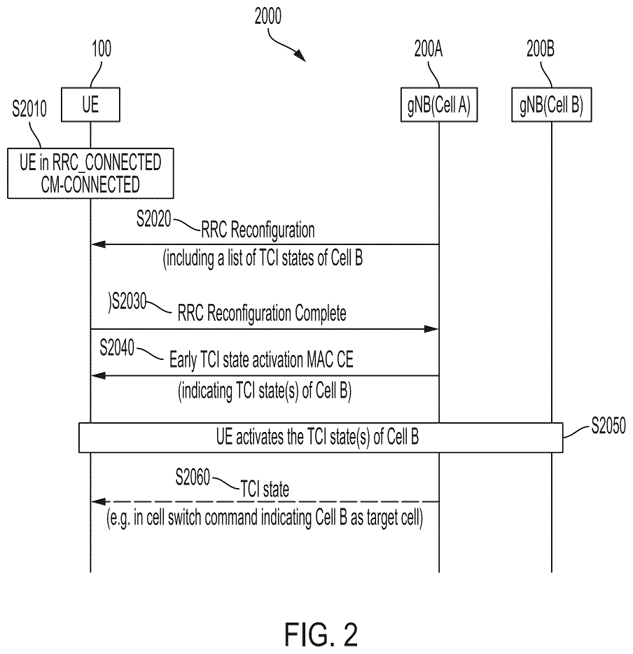

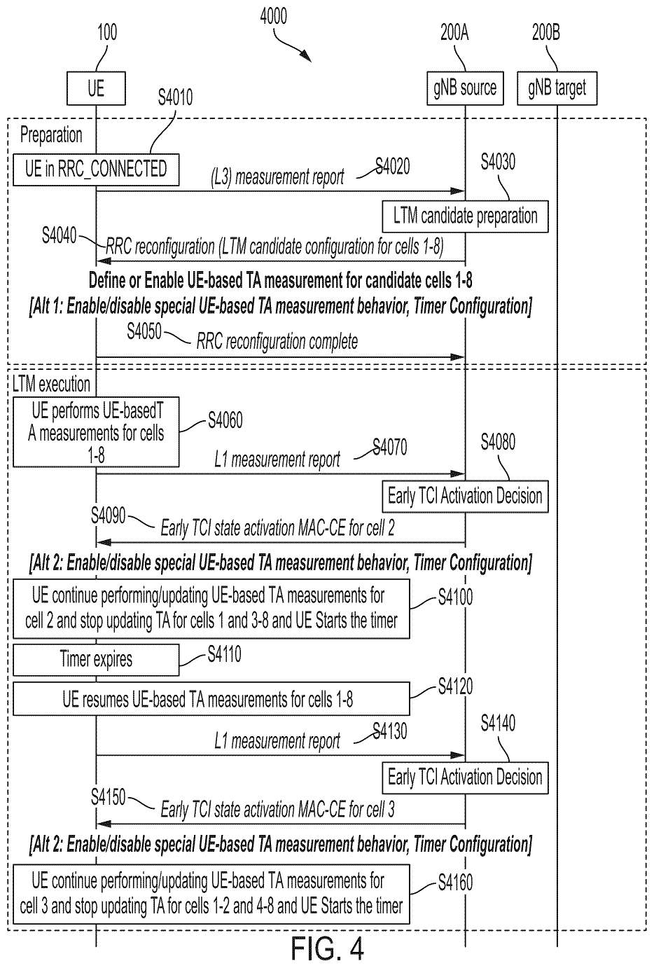

FIG. 1 illustrates an example signal diagram 1000 of communications between a user equipment (UE) 100, and a network base station (gNB) 200, according to certain example embodiments. The UE 100 may be an electronic device such as a cell phone, computer, tablet, etc. The UE 100 and network cells may have hardware organized into layer 1 (L1), layer 2 (L2), and layer 3 (L3). Each of the layers may be responsible for different processing and signalling. The network base station 200 may be a network element configured to communicate with user elements. The signal diagram includes example signals and determinations in a process of establishing layer 1/layer 2 triggered mobility (LTM). These communications can be improved and enhanced by combining the operations of FIG. 1 with the operations of FIG. 2 as shown in FIG. 4.

The UE 100 and gNB 200 may perform LTM preparations. At S1010, the UE 100 may perform radio resource control (RRC) operations with the gNB to establish a connection with the gNB.

At S1020, the UE may send a measurement report message to the gNB. For example, the measurement report may be a layer 3 measurement report of the candidate cells.

At S1030, the gNB may determine to configure LTM and initiate candidate cell(s) preparation. Configuring the LTM may be performed with a different RRC configuration than is initially established between the UE 100 and gNB 200.

At S1040, the gNB 200 may transmit an RRC reconfiguration message to the UE including the LTM candidate cell configurations of one or multiple candidate cells at the UE 100. The UE 100 may receive the RRC reconfiguration message.

At S1050, the UE 100 may perform RRC reconfiguration and send an RRC reconfiguration complete message. The RRC reconfiguration may include configurations for operation (signals and determinations, etc.) in LTM execution. The UE stores the LTM candidate cell configurations and transmits an RRC Reconfiguration Complete message to the gNB 200.

The UE 100 and gNB 200 may then perform early synchronization. At S1060, the UE 100 may perform downlink (DL) synchronization with candidate cell(s) before receiving the cell switch command. The DL synchronization for a candidate cell may be performed using SSBs or Channel State Information Reference Signals (CSI-RSs) of the candidate cell. Early TCI activation may be used to trigger DL synchronization using one or more RSs (associated with the TCI states indicated in the TCI activation command) associated with one or more candidate cells.

At S1070, the UE 100 and gNB 200 may perform uplink (UL) synchronization with candidate cells. The UE may perform early timing advance (TA) acquisition (with candidate cell(s) requested by the network) before receiving the cell switch command. This may be done via contention free random access (CFRA) triggered by a physical downlink control channel (PDCCH) order from the source cell. After the PDCCH order from the source cell, the UE may send a preamble towards the indicated candidate cell. In order to minimize the data interruption of the source cell due to CFRA towards the candidate cell(s), the UE may not receive random access response (RAR) for the purpose of TA value acquisition. The TA value of the candidate cell may also be indicated in the cell switch command. The UE may not maintain the TA timer for the candidate cell and instead rely on network implementation to guarantee the TA validity. Other methods for early TA acquisition may also be utilized. In one example, if the TA of the target cell (gNB 200) equals to 0 or is the same as the source cell (gNB 100), the source cell (gNB 100) may directly (e.g., without triggering any UE preamble transmission) include the TA value in the cell switch command. In another example, UE-based TA measurement may be used where the UE 100 may be configured to derive the TA based on Rx timing difference between current serving cell (gNB 100) and candidate cell (gNB 200) as well as TA value for the current serving cell (gNB 100). The UE 100 may indicate its capability to support UE-based TA measurements along with a number of candidate cells the UE 100 can support for UE-based TA measurements. Then the network may configure the UE-based TA measurement for one or more candidate cells based on the UE capability.

The UE 100 and gNB 200 may then perform LTM execution. At S1080, the UE may perform L1 measurements on the configured candidate cell(s) and transmit lower-layer (e.g. layer 1) measurement reports to the gNB 200. L1 measurements may be performed as long as the RRC reconfiguration of S1040 is applied. The operations of L1 measurements and L1 measurement report may be performed several times before the cell switch decision is sent.

At S1090, the gNB 200 may decide to execute the cell switch to a target cell (LTM decision). At S1100, the gNB 200 may transmit a medium access control (MAC) control element (MAC-CE) triggering the cell switch by including the identity of the target cell, e.g., candidate configuration index of the target cell. The UE may switch to the target cell and apply the target cell configuration given in the RRC.

At S1110, the UE 100 may execute the cell switch command and detach from source gNB 200 and apply the target cell configuration indicated in the MAC-CE triggering cell switch.

At S1120, the UE 100 may perform the random access channel (RACH) procedure for the target cell in order to acquire the TA, if the UE 100 does not have a valid TA of the target cell.

The UE 100 and gNB 200 may then complete the LTM cell switch procedure. At S1130, the UE 100 may complete the LTM cell switch procedure by sending RRC reconfiguration complete message to target cell. If the UE 100 has performed a RA procedure in S1110 the UE 100 may consider that LTM execution is successfully completed when the random access procedure is successfully completed. For RACH-less LTM, the UE 100 may consider that LTM execution is successfully completed when the UE 100 determines that the network has successfully received its first UL data. The UE 100 may determine successful reception of the first UL data by receiving a PDCCH addressing the UE's 100 cell-radio network temporary identifier (C-RNTI) in the target cell. The UE's C-RNTI may schedule a new transmission following the first UL data.

The operation S1060-S1120 can be performed multiple times for subsequent LTM cell switch using the LTM candidate cell configuration(s) provided in S1040.

FIG. 2 illustrates an example signal diagram 2000 of communications between a UE 100, a gNB for cell A 200A, and a gNB for cell B 200B, according to certain example embodiments. A unified TCI state framework may be used in LTM. LTM cell switch command may indicate a TCI state of the target cell for the UE. TCI state activation for LTM candidate cells may be performed before receiving the actual cell switch at the UE using a separate MAC-CE for one or more joint and/or separate DL and UL TCI states. The early TCI state activation may be done for one or more candidate cells. If not performed before the cell switch, the cell switch command may both activate and indicate the target TCI state.

At S2010, the UE 100 may be RRC connected and connection management (CM)-connected for communication with the gNB 200A.

At S2020, the gNB 200A (to which Cell A belongs) may provide a list of TCI states of Cell B to the UE 100 within the RRC Reconfiguration message. The gNB 200A may provide a list of TCI state(s) for one or multiple candidate cells to which the early TCI state activation procedure may be executed by the UE 100.

At S2030, the UE 100 replies with the RRC Reconfiguration Complete message.

At S2040, the gNB 200A may send an early TCI state activation MAC-CE to the UE to initiate an early TCI state activation procedure with Cell B. The early TCI state activation may indicate TCI state(s) of one or multiple cells to be included in the TCI state activation procedure.

At S2050, the UE 100 may activate the TCI state(s) of Cell B indicated in the early TCI state activation MAC CE. With TCI activation, the UE 100 may start tracking timing using the reference signals associated with the indicated TCI state(s) of the candidate cells in the activation command. The UE 100 may have an early DL synchronization with the gNB 200B. The gNB 200A may initiate cell switch procedure to Cell B by providing a cell switch command which indicates Cell B as target cell. The cell switch command can be, for example, the LTM cell switch MAC-CE.

At S2060, the gNB 200A may provide the TA value calculated by the gNB 200B during the TA acquisition procedure (e.g., in LTM cell switch command MAC-CE which initiate cell switch procedure to Cell B).

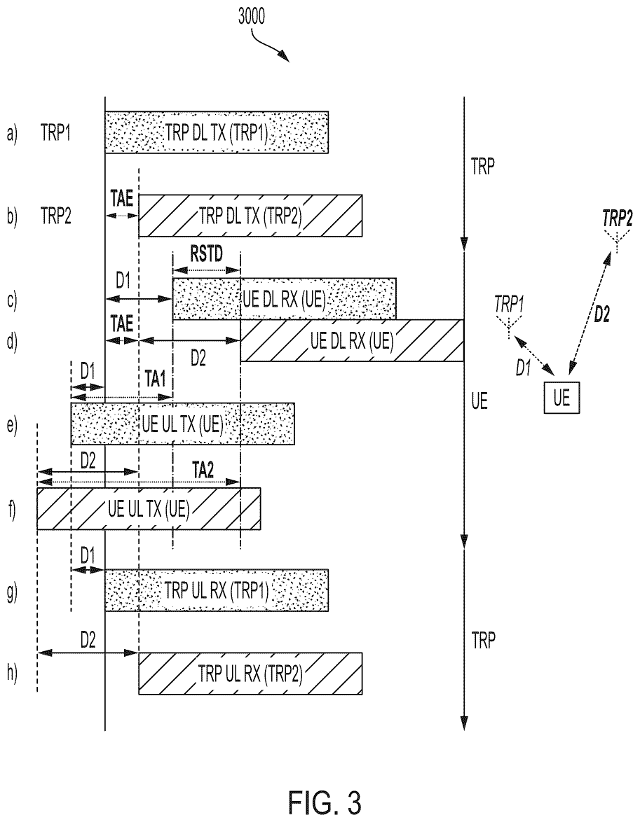

FIG. 3 illustrates an example timing diagram 3000 for the UE-based Timing Advance Acquisition, according to certain example embodiments. Timing Advance TA2 for the second cell (candidate cell) may be determined using equation (1):

$$TA 2 = TA 1 + 2 RSTD - 2 Realized ( TAE ) - Other Est Error \qquad ( 1 )$$

TA1 may be a timing advance of the first cell (current serving cell). Timing Alignment Error (TAE) may be a relative difference in time of transmission of the simultaneous signals between any pair of two cells. TAE may be defined in the context of MIMO transmissions from a cell, with the maximum value not exceeding 3000 ns and an extension of the definition for LTM being under discussion in 3GPP. Realized TAE may, for example, mean the realized difference between the candidate cell and the current serving cell. RSTD may mean a relative timing difference between two cells. OtherEstError may refer to any error that can be caused by the UL/DL reciprocity or estimator implementation/method error.

Cell phase synchronization accuracy for TDD may be defined as the maximum absolute deviation in frame start timing between any pair of cells on the same frequency that have overlapping coverage areas and may be less than 3000 ns.

In the context of DL positioning, a Tx timing error may be defined as the result of Tx time delay involved in the transmission of a signal. Tx time delay involved in the transmission of a signal may be defined as the time delay from the time when the digital signal is generated at baseband to the time when the RF signal is transmitted from the Tx antenna.

In addition, the information element new radio-round trip delay (NR-RTD)-Info may be used by the location server to provide time synchronization information between a reference cell (serving cell) and a list of neighbor cells. The definitions, information elements and relevant mechanisms in the specification allow the UE to become aware of timing misalignments in the transmissions from different cells and take them into account in position estimation.

FIG. 4 illustrates an example signal diagram 4000 of communications between a UE 100, a gNB source 200A, and a gNB target 200B, according to certain example embodiments. The gNB 200A may be associated with a source cell and gNB 200B may be associated with a target cell. The signal diagram 4000 includes signals and operations for the selection of the target cell and the configuration of the UE 200 for communication with the target cell via the gNB 200B. Many of the operations, signals, and determinations in signal diagram 4000 are similar to the operations, signals, and determinations in signal diagrams 1000 and 2000. Description of similar operations may be omitted or include reduced detail. Signal diagram 4000 shows how contemporaneous execution of the operations, signals, and determinations in signal diagrams 1000 and 2000 can result in acquisition of timing advance TA2 for the candidate cell.

At S4010, the UE 100 may be in RRC connected state with gNB 200A. At S4020, the UE 100 may perform L3 measurements on candidate cells and send an L3 measurement report to the gNB 200A. At S4030, the gNB 200A may determine LTM candidate cell configuration based on a measurement and reporting configuration for candidate cells with the related TCI state configurations. As an example, 8 cells (cells 1-8) are described, however any number of candidate cells may be included. Each candidate cell may be associated with a base station. The eventual target cell may be associated with the gNB target 200B.

At S4040, the gNB 200A may determine an RRC reconfiguration for LTM candidate configuration for the candidate cells. The RRC reconfiguration may define or enable UE-based TA measurement for the candidate cells. The UE-based TA measurement may be enabled or disabled for each candidate cell or a set of candidate cells. The RRC may additionally enable or disable a special UE-based TA measurement behavior, as well as a timer or other conditions for the special UE-based TA measurement behavior (this information may also be included in the RRC reconfiguration of S1040 of FIG. 1 or 2020 of FIG. 2). The special UE-based TA measurement may be enabled or disabled for each candidate cell or a set of candidate cells. In one example, for a candidate cell, the special UE-based TA measurement is enabled for a set of TCI states or reference signals (SSBs/CSI-RSs). The RRC reconfiguration message may define UE-based TA measurement behavior after TCI state activation or enable/disable predefined UE-based measurement behavior after TCI state activation. In another example, TCI activation command may contain an indication to enable special UE-based TA measurement for the candidate cells or RSS (SSBs/CSI-RSs) associated with the TCI state(s) being activated by the command. In another example, TCI activation command may contain an indication to enable special UE-based TA measurement only for a sub-set of candidate cells or RSS (SSBs/CSI-RSs) from the set of candidate cells or RSs (SSBs/CSI-RSs) associated with the TCI state(s) being activated by the command. The special UE-based TA measurement behavior may include only performing UE-based TA measurements on the early TCI state activated candidate cells (e.g., candidate cells for which one or more TCI states are activated) or only performing UE-based TA measurements on the reference signals (SSBs/CSI-RSs) associated with the TCI states which are activated, or performing UE-based TA measurements on the early TCI state activated cells or RSs more frequently than on other configured cells for UE-based TA measurements. As another example, if the UE 100 has been performing UE-based TA measurements for a set of configured candidate cells or RSs before a TCI activation command is received by the UE, after the reception of a TCI activation command the UE 100 may only continue performing UE-based TA measurements on the TCI state activated cells or RSs available or applicable after the TCI activation command. Even after one or more TCI activation command, the UE-based TA measurements may only be performed with candidate cells with active TCI state(s) which are configured or enabled for UE-based TA measurements in RRC. For example, the UE may not perform any UE-based TA measurement with one or more active TCI states if that candidate cell is not configured or enabled for UE-based TA measurement in RRC. The network may not configure certain candidate cells for UE-based TA measurement for example when the time alignment error between the serving and candidate cell is large. Conditions for ending the special UE-based TA measurement behavior may also be defined in the RRC reconfiguration message. Alternatively, these conditions may be pre-programmed in the UE such that the conditions for triggering and ending the special UE-based TA measurement behavior are included in instructions in a memory of the UE 100. Additionally, these conditions may be defined in a standard.

In another example, an indication to enable/disable the UE-based TA measurement behavior after TCI state activation may be included in another RRC message, the RRC message may also include the conditions for ending the special UE-based TA measurement.

Events triggering the special UE-based TA measurement behavior may include an early TCI state activation MAC-CE for a particular cell or a message from the gNB 200A indicating to begin the special UE-based TA measurement behavior.

Events triggering the end of the special UE-based TA measurement behavior may include: UE 100 receives LTM cell switch command; a predefined or network indicated time has passed (e.g., timer); UE 100 receives another TCI state activation command; UE 100 receives another TCI state deactivation command; gNB 200A indicates network has reconfigured LTM candidate cells with a new LTM candidate cell configuration (including or not including the candidate cell(s) being currently measured); a new LTM configuration is given to the UE (this may be applicable when the TCI state is activated before the cell switch is retained); UE 100 receives a message from the gNB 200A indicating to end the special UE-based TA measurement behavior. In one example, when the UE receives another TCI state activation command or a TCI state deactivation command, the UE may update the special UE-based TA measurement behavior based on the candidate cells or RSs activated or deactivated by new TCI state activation or deactivation command. A new TCI state activation or deactivation command may update the list of active TCI states; therefore the UE 100 may apply the special UE-based TA measurement behavior based on the updated list of active TCI states. For example, if a candidate cell is deactivated (all the active TCI states associated with that candidate cell are deactivated) based on a new TCI activation command or a TCI deactivation command, the UE may stop or relax UE-based TA measurements for that candidate cell. In another example, if a TCI state is deactivated based on a new TCI activation command or a TCI deactivation command, the UE may stop or relax UE-based TA measurements for the RS associated with that TCI state. If a new TCI state is activated by a new TCI activation command, the UE may apply the special UE-based TA measurement for the newly activated TCI state. For example, the UE may start (if no UE-based TA measurement was performed for that TCI state) or continue with the same or increased measurement frequency, the UE-based TA measurement for the newly activated TCI state. In one example, when the special UE-based TA measurement behavior continues after a cell switch, the special UE-based TA measurement may be continued for all the candidate cells with the active TCI states. In another example, when the special UE-based TA measurement behavior continues after a cell switch, the special UE-based TA measurement may be continued for all the candidate cells with the active TCI states except the target cell (new serving cell after the cell switch). In another example, when the special UE-based TA measurement behavior continues after a cell switch, the special UE-based TA measurement may be continued only for the previous serving cell or/and candidate cells with active TCI states. After a cell switch, the UE may use the new serving cell as a reference cell for UE-based TA measurements for the candidate cells.

At S4050, the UE 100 may reconfigure according to the RRC reconfiguration message and send a RRC reconfiguration complete message to the gNB 200A.

At S4060, the default measurement behavior (first measurement behavior) for the UE 100 may start after the RRC reconfiguration complete message is sent and continue until a trigger for the special measurement behavior is received by the UE 100. The first measurement behavior includes RSTD (or TA) measurements according to UE-based TA measurement configuration given in the LTM candidate cell configuration and based on UE measurement capability (as an example UE 100 is capable of performing UE-based TA measurements on cells 1-8). In another example, according to the default measurement behavior (first measurement behavior), the UE 100 may not perform any UE-based TA measurement until a trigger for the special measurement behavior is received by the UE 100.

At S4070, the UE 100 may perform L1 measurements and report L1 measurements based on the LTM configuration and UE measurements to the gNB 200A. At S4080 the gNB 200A may determine an early activation decision based on the L1 measurement report. The selection of the cell for early TCI state activation may be chosen based on the L1 measurement report, predicted delay, available network resources, etc.

At S4090 the gNB 200A may send an early TCI state activation MAC-CE for one of the cells (as an example, cell 2 is indicated in the signal diagram 4000, however, any of the cells may be indicated). Additionally, if the enable/disable special UE-Based TA measurement behavior was not previously sent, the gNB 200A may send the enable/disable special UE-Based TA measurement behavior indication with the enable/disable special UE-Based TA measurement behavior (as another example, this information may also be included in the operation 2040 of FIG. 2). The enable or disable may be indicated with a one bit value (e.g., 1/0=enable/disable). In one example, the enablement or disablement may be indicated separately for each candidate cell or TCI state being indicated in the activation command. The TCI activation command may enable special UE-Based TA measurement behavior only for a sub-set of candidate cells or RSs/TCI States being activated by the command.

At S4100, the UE 100 may determine that the trigger of the Early TCI state activation for MAC-CE for cell 2 has triggered the special measurement behavior and may perform the special measurement behavior. The UE 100 may perform the special measurement behavior by performing no measurements or relaxed measurements for other candidate cells than the ones with at least one active TCI state. The special measurement behavior may be either a predefined behavior or a network indicated behavior. For example, TA measurements on cells 1 and 3-8 may be stopped if the UE was performing UE-based TA measurements on those cells, while TA measurements on cell 2 may continue with the same frequency because only cell 2 is in an active TCI state. In another example, for other cells/RSs without any associated active TCI state, instead of a complete stop, the UE may relax the measurements (e.g., frequency/periodicity of UE-based TA measurement for those cells/RSs (not associated with the active TCI states) may be lower compared to the cells/RSs (associated with the active TCI states)). Different values of the periodicity to be used in different conditions. In one example, the UE may relax the measurements for a certain amount of time or samples (e.g., defined by number of measurement occasions). In another example, the UE may perform measurements on reduced number of carriers for cells/RSs not associated with the active TCI states. In another example, the UE 100 may not be configured to perform any UE-based TA measurements until a trigger for the special measurement behavior is received by the UE 100 (before any TCI activation), and the UE 100 may perform the special UE-based measurement behavior by start performing UE-based TA measurements after a TCI activation command on cells/RSs indicated in the TCI activation command. If a timer configuration was also included in the early TCI state activation MAC-CE for cell 2, the timer is started when the TCI state activation command is received. The timer configuration may be included in RRC reconfiguration at S4040. When the timer expires the UE stops the special measurement behavior (so long as another trigger for stopping the special measurement behavior has not occurred first). In one example, the timer configuration may be configured for each candidate cell or each TCI state and the timer of the candidate cell or TCI states starts when the TCI state activation command for that candidate cell is received. When the timer expires the UE 100 may stop the special measurement behavior for that candidate cell or TCI state.

If the network is activating TCI states with separate MAC-CEs for more than one candidate cell or RS, the UE may perform UE-based TA measurements only to the one or up to X candidate cells or RSs for which TCI state activation was done last (latest). The UE 100 may only continue performing UE-based TA measurements on X≥1 candidate cells or RSs with the latest TCI state activation MAC-CE and relax/skip measurements on other candidate cells or RSs. In one example, the UE may signal its capability in terms of maximum number of candidate cells (L) for which the UE may perform UE-based TA measurements, and the value of X (<=L) can be configured to the UE.

In one example, the UE 100 may receive an indication to initiate (or continue) the UE based TA measurements. If the UE 100 has received a MAC CE activating at least one candidate cell TCI state, it may determine to perform the TA measurements on the RS included in the active TCI states. In one further example the indication to initiate the UE based TA measurement may comprise an information whether the UE performs TA measurement on a specific target RS or it uses RS of activated TCI states. This may be cell specifically configured/indicated.

In one example, in case of early beam (TCI state) indication for LTM, the above proposed UE behavior for UE-based TA measurement may be applied with respect to the candidate cells or RSs associated with the indicated beam(s). For example, the UE may continue UE-based TA measurements for the candidate cells/RSs for which the beam is indicated, and the UE may stop or relax the UE-based TA measurement for other candidate cells and RSs. In another example, when the default (first behavior) includes no UE-based TA measurements, after a beam indication is received by the UE 100, the UE 100 may initiate UE-based TA measurements for the candidate cells/RSs for which the beam is indicated. Even after a beam indication for a candidate cell, the UE-based TA measurements may be performed with the candidate cells if this candidate cell is configured or enabled for UE-based TA measurements in RRC.

In one example, the UE-based measurements for a specific candidate cell may be further determined based on the RACH-based TA acquisition status for the candidate cell. In one example, for a candidate cell/RSs for which the UE is configured to perform UE-based TA measurements and the UE has performed at least one PRACH transmission (e.g., LTM PRACH), the UE stops or relaxes UE-based TA measurements for that candidate cell. In one example, if the UE receives at least one new TCI state activation including TCI states for a candidate cell for which one PRACH transmission has been performed, the PRACH based UE-based TA measurement behavior (not performing or relaxing UE-based TA measurement) may not be applied (until new PRACH is transmitted). The current TCI state activation may be independent of how the TCI state activation for multiple cells occurs. For example, there may be separate or common MAC-CE and each MAC-CE for early TCI state activation may apply on top of the previous MAC-CE(s). Further, the TCI state activations may be overwritten or cancelled.

UE measurement behavior may be predefined in the standard, or the network may define the expected UE measurement behavior. For example, in the LTM candidate cell configuration or another network message to the UE, or the network may enable/disable predefined UE measurement behavior after TCI state activation dynamically (e.g., in LTM candidate cell configuration or the early TCI state activation command). In one example, the UE-based TA measurement behavior may be configured (enable or disable) for each candidate cell. In another example, for a candidate cell, UE-based TA measurement behavior may be configured (enable or disable) for each TCI state.

At S4110, the UE 100 determines that the timer has expired (alternatively, another trigger to stopping the special measurement behavior has occurred) and the UE 100 stops the special measurement behavior. At S4120 the UE 100 resumes UE based TA measurements for cells 1-8 at the initial frequency (e.g., the first measurement behavior). In another example, when the UE determines that the timer has expired (or when another trigger to stopping the special measurement behavior has occurred), the UE 100 stops UE-based TA measurements for all the candidate cells. For example, the UE is configured to not perform any UE-based TA measurement before receiving a TCI activation command. In another example, the ending event/condition for special UE-based TA measurement may be configured for each candidate cell or for each TCI state of a candidate cell, and after an ending trigger occurs for a candidate cell or a TCI state (the timer associated with the candidate cell or TCI state has expired or another trigger to stop the special measurement behavior for that candidate cell or TCI state has occurred), the UE 100 stops the special measurement behavior for that candidate cell or TCI state.

At S4130, the UE 100 may continue performing and reporting L1 measurements. At S4140, the gNB 200A may determine that early TCI activation for a different cell is desired. This determination may be made based on changing network or channel state, changed L1 measurements, or for other reasons. The gNB 200A may also determine that the special behavior may be resumed (the gNB 200A may know that the special measurement behavior has ceased due to the sent timer configuration or a triggering event from the gNB 200A). The gNB 200A may determine that the special behavior may resume in order to reduce the TA measurement load of the UE 100 and delays associated with the TA measurement load.

At S4150, the gNB 200A may send the early TCI state activation MAC-CE with the enable special UE-based TA measurement behavior command included. As an example, the early TCI state activation MAC-CE is for cell 3 and a timer configuration is also included. The timer configuration may be included in the RRC reconfiguration at S4040. In some example embodiments, the enable/disable special UE-based TA measurement behavior is sent to change the enable/disable state and is not sent when the enable/disable state is not changed. For example, the enable/disable state may still be enabled so the gNB 200A may not include the enable special UE-based TA measurement behavior command with the Early TCI state activation MAC-CE for cell 3.

At S4160, the UE 100 may determine that the early TCI state activation MAC-CE for cell 3 is a trigger and begin special measurement behavior and perform/update UE-based TA measurements for cell 3 and reduce or stop measurements and updates for cells 1, 2, and 4-8. The UE 100 may also start a timer based on the received timer configuration. UE 100 may perform TA measurements according to measurement behavior either based on predefined or network indicated behavior. In this example, the special measurement behavior only applies for one cell at the time, which is why the UE is only performing TA measurement for cell 3 and not cell 2. However, in another example, the TCI state(s) that were earlier activated for cell 2 can also be considered active, and the UE can continue TA measurements on both cell 2 and cell 3.

At S4170, the UE 100 may continue L1 measurements and reporting L1 measurements.

At S4180, the gNB 200A may determine an LTM decision. In this example the decision is for cell 3 to be the target cell. At S4190, the gNB 200A may send the LTM cell switch command (MAC-CE) to cell 3 to the UE 100.

At S4200 the UE 100 may detach from the source gNB 200A according to the LTM cell switch command to cell 3. The UE 100 may reconfigure for the target cell 3 according to the TA measurements for cell 3.

The UE 100 and gNB target 200B may then complete LTM. At 4210 the UE 100 and gNB target 200B may perform RACH procedure to connect.

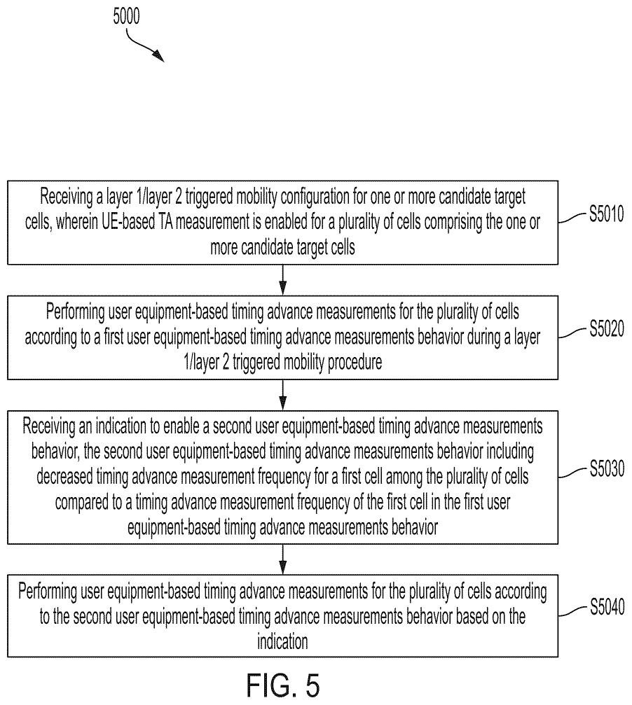

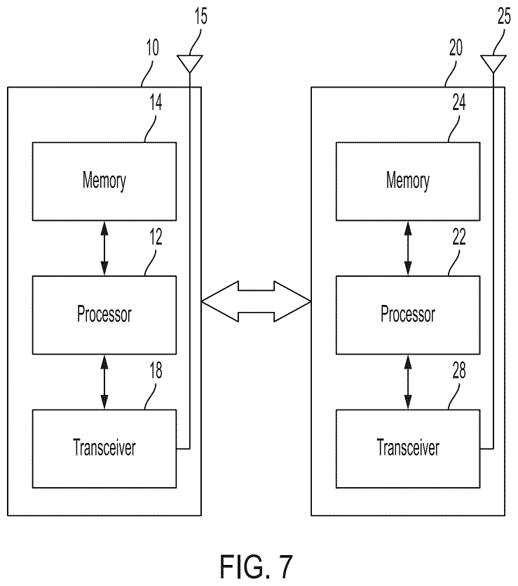

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a UE or computer implementing an application and/or AF, the UE and computer being similar to one of apparatuses 10 or 20 illustrated in FIG. 7.

According to certain example embodiments, the method of FIG. 5 may include, at S5010, receiving a layer 1/layer 2 triggered mobility configuration for one or more candidate target cells, wherein UE-based TA measurement is enabled for a plurality of cells comprising the one or more candidate target cells, at S5020, performing user equipment-based timing advance measurements for the plurality of cells according to a first user equipment-based timing advance measurements behavior during a layer 1/layer 2 triggered mobility procedure, at S5030, receiving an indication to enable a second user equipment-based timing advance measurements behavior, the second user equipment-based timing advance measurements behavior including decreased timing advance measurement frequency for a first cell among the plurality of cells compared to a timing advance measurement frequency of the first cell in the first user equipment-based timing advance measurements behavior, and at S5040, performing user equipment-based timing advance measurements for the plurality of cells according to the second user equipment-based timing advance measurements behavior based on the indication.

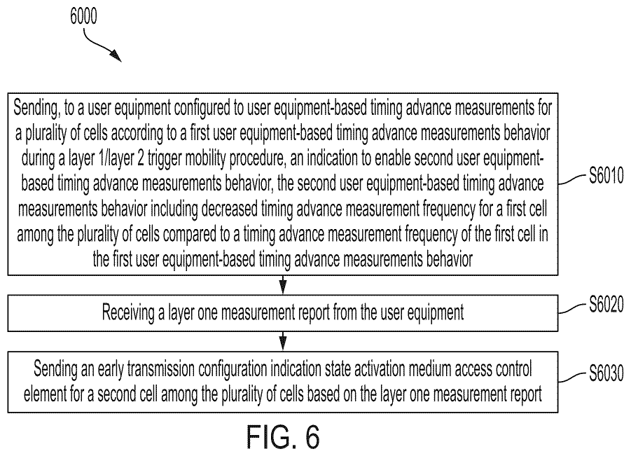

FIG. 6 illustrates an example flow diagram of another method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by the network (e.g., gNB, 5G core, or 5G RAN) similar to one of apparatuses 10 or 20 illustrated in FIG. 7.

According to certain example embodiments, the method of FIG. 6 may include, at S6010, sending, to a user equipment configured to user equipment-based timing advance measurements for a plurality of cells according to a first user equipment-based timing advance measurements behavior during a layer 1/layer 2 trigger mobility procedure, an indication to enable second user equipment-based timing advance measurements behavior, the second user equipment-based timing advance measurements behavior including decreased timing advance measurement frequency for a first cell among the plurality of cells compared to a timing advance measurement frequency of the first cell in the first user equipment-based timing advance measurements behavior, at S6020, receiving a layer one measurement report from the user equipment, and at S6030, sending an early transmission configuration indication state activation medium access control element for a second cell among the plurality of cells based on the layer one measurement report.

FIG. 7 illustrates a set of apparatuses 10 and 20 according to certain example embodiments. In certain example embodiments, apparatuses 10 and 20 may be elements in a communications network or associated with such a network. For example, apparatus 10 may be an AF or application implemented on a computing device or machine such as, for example, a UE, and apparatus 20 may be a network (i.e., gNB, 5GS, 5G Core, 5G RAN, etc.).

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 9.

As illustrated in the example of FIG. 9 apparatuses 10 and 20 may include or be coupled to a processor 12 and 22 for processing information and executing instructions or operations. Processors 12 and 22 may be any type of general or specific purpose processor. In fact, processors 12 and 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 and 22 is shown in FIG. 7, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-4.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-4.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

CSI-RS Channel State Information Reference Signal
gNB gNodeB
L1/L2/L3 Layer 1/2/3
LTM L1/L2 triggered mobility
MAC-CE Medium access control element
PDCCH Physical Downlink Control Channel
PRACH Physical Random-access Channel
QCL Quasi Co-location
RACH Random-access Channel
RRC Radio resource control
RS Reference Signal
RSTD Reference Signal Time Difference
SSB Synchronization Signal Block
TA Timing Advance
TAE Timing Alignment Error
TCI Transmission configuration indication
UE User equipment

We claim:

1. A method comprising:
receiving a layer 1/layer 2 triggered mobility configuration for one or more candidate target cells, wherein UE-based TA measurement is enabled for a plurality of cells comprising the one or more candidate target cells;
performing user equipment-based timing advance measurements for the plurality of cells according to a first user equipment-based timing advance measurements behavior during a layer 1/layer 2 triggered mobility procedure;
receiving an indication to enable a second user equipment-based timing advance measurements behavior, the second user equipment-based timing advance measurements behavior including decreased timing advance measurement frequency for a first cell among the plurality of cells compared to a timing advance measurement frequency of the first cell in the first user equipment-based timing advance measurements behavior; and
performing user equipment-based timing advance measurements for the plurality of cells according to the second user equipment-based timing advance measurements behavior based on the indication.

2. The method of claim 1, wherein the indication to enable the second user equipment-based timing advance measurements behavior is included in a radio resource control configuration message.

3. The method of claim 1, further comprising:
determining an end condition for the second user equipment-based timing advance measurements behavior has been met; and
performing user equipment-based timing advance measurements for the plurality of cells according to the first user equipment-based timing advance measurements behavior based on the determining the end condition for the second user equipment-based timing advance measurements behavior has been met.

4. The method of claim 3, wherein the end condition comprises at least one of:
a timer expiring;
a received layer 1/layer 2 trigger mobility cell switch command;
a received transmission configuration indication state activation or deactivation command; or
a received layer 1/layer 2 trigger mobility candidate cell configuration reconfiguring the plurality of cells.

5. The method of claim 1, wherein the timing advance measurement frequency for a second cell among the plurality of cells in the first user equipment-based timing advance measurements behavior is the same as the timing advance measurement frequency for the second cell in the second user equipment-based timing advance measurements behavior.

6. The method of claim 5, further comprising:
receiving a transmission configuration indication state activation medium access control element for the second cell,
wherein the performing user equipment-based timing advance measurements for the plurality of cells according to the second user equipment-based timing advance measurements behavior is further based on the transmission configuration indication state activation medium access control element for the second cell.

7. The method of claim 5, further comprising:
receiving a transmission configuration indication state indication for the second cell,
wherein the performing user equipment-based timing advance measurements for the plurality of cells according to the second user equipment-based timing advance measurements behavior is further based on the transmission configuration indication state indication for the second cell.

8. An apparatus, comprising:
at least one processor; and
at least one memory comprising computer program code,
the at least one memory and the computer program code are configured, with the at least one processor, to cause the apparatus at least to:
receive a layer 1/layer 2 triggered mobility configuration for one or more candidate target cells, wherein UE-based TA measurement is enabled for a plurality of cells comprising the one or more candidate target cells;
perform user equipment-based timing advance measurements for the plurality of cells according to a first user equipment-based timing advance measurements behavior during a layer 1/layer 2 triggered mobility procedure;
receive an indication to enable a second user equipment-based timing advance measurements behavior, the second user equipment-based timing advance measurements behavior including decreased timing advance measurement frequency for a first cell among the plurality of cells compared to a timing advance measurement frequency of the first cell in the first user equipment-based timing advance measurements behavior; and
perform user equipment-based timing advance measurements for the plurality of cells according to the second user equipment-based timing advance measurements behavior based on the indication.

9. The apparatus of claim 8, wherein the indication to enable the second user equipment-based timing advance measurements behavior is included in a radio resource control configuration message.

10. The apparatus of claim 8, wherein the at least one memory stores instructions that, when executed by the at least one processor, cause the apparatus to:
determine an end condition for the second user equipment-based timing advance measurements behavior has been met; and
perform user equipment-based timing advance measurements for the plurality of cells according to the first user equipment-based timing advance measurements behavior based on the determining the end condition for the second user equipment-based timing advance measurements behavior has been met.

11. The apparatus of claim 10, wherein the end condition is one of:
a timer expiring;
a received layer 1/layer 2 trigger mobility cell switch command;
a received transmission configuration indication state activation or deactivation command; and
a received layer 1/layer 2 trigger mobility candidate cell configuration reconfiguring the plurality of cells.

12. The apparatus of claim 8, wherein the timing advance measurement frequency for a second cell among the plurality of cells in the first user equipment-based timing advance measurements behavior is the same as the timing advance measurement frequency for the second cell in the second user equipment-based timing advance measurements behavior.

13. The apparatus of claim 12, wherein the at least one memory stores instructions that, when executed by the at least one processor, cause the apparatus to:
receiving an transmission configuration indication state activation medium access control element for the second cell,
wherein the performing user equipment-based timing advance measurements for the plurality of cells according to the second user equipment-based timing advance measurements behavior is further based on the transmission configuration indication state activation medium access control element for the second cell.

14. The apparatus of claim 12, wherein the at least one memory stores instructions that, when executed by the at least one processor, cause the apparatus to:
receive a transmission configuration indication state indication for the second cell,
wherein the performing user equipment-based timing advance measurements for the plurality of cells according to the second user equipment-based timing advance measurements behavior is further based on the transmission configuration indication state indication for the second cell.

15. The apparatus of claim 12, wherein the timing advance measurement frequency for all but the second cell among the plurality of cells in the second user equipment-based timing advance measurements behavior is zero.

16. The apparatus of claim 8, wherein the at least one memory stores instructions that, when executed by the at least one processor, cause the apparatus to:
transmitting a preamble on physical random-access channel (PRACH) to the first cell,
wherein the performing user equipment-based timing advance measurements for the plurality of cells according to the second user equipment-based timing advance measurements behavior is further based on the transmission of the preamble on PRACH to the first cell.

17. An apparatus, comprising:
at least one processor; and
at least one memory comprising computer program code,
the at least one memory and the computer program code are configured, with the at least one processor, to cause the apparatus at least to
send, to a user equipment configured to perform user equipment-based timing advance measurements for a plurality of cells according to a first user equipment-based timing advance measurements behavior during a layer 1/layer 2 trigger mobility procedure, an indication to enable second user equipment-based timing advance measurements behavior, the second user equipment-based timing advance measurements behavior including decreased timing advance measurement frequency for a first cell among the plurality of cells compared to a timing advance measurement frequency of the first cell in the first user equipment-based timing advance measurements behavior;
receive a layer one measurement report from the user equipment; and
send an early transmission configuration indication state activation medium access control element for a second cell among the plurality of cells based on the layer one measurement report.

18. The apparatus of claim 17, wherein the indication to enable second user equipment-based timing advance measurements behavior is included in a radio resource control configuration message.

19. The apparatus of claim 17, wherein the indication also indicates for the timing advance measurement frequency for the second cell in the second user equipment-based timing advance measurements behavior is the same as the timing advance measurement frequency for the second cell in the second user equipment-based timing advance measurements behavior.

20. The apparatus of claim 17, wherein the indication includes an indication of one or more end conditions for the second user equipment-based timing advance measurements behavior.
